(19) United States
(12) Patent Application Publication
(10) Pub. No.: US 2014/0156745 A1
(43) Pub. Date: Jun. 5, 2014

(54) DISTRIBUTING USER INFORMATION ACROSS REPLICATED SERVERS

(71) Applicant: Facebook, Inc., Menlo Park, CA (US)

(72) Inventors: Ming Hua, Mountain View, CA (US); Hong Yan, Mountain View, CA (US)

(21) Appl. No.: 13/690,338

(22) Filed: Nov. 30, 2012

(51) Int. Cl. G06F 15/16

(52) U.S. Cl. CPC G06F 15/16
USPC 709/204

(57) ABSTRACT

Online systems store information describing a large number of users in order to process requests accessing the user information. The user information is distributed across multiple servers. The distribution is performed so that the information is available even if one or more servers fail. The user information is distributed across a first set of servers and a second copy of the user information is distributed across a second set of servers. The user information from each server of the first set is uniformly distributed across multiple servers from the second set, for example, using random distribution, round robin strategy, or any other strategy that uniformly distributes the information across a given set of processors. Requests previously directed to a failed server are redistributed across multiple servers thereby load balancing the processing of these requests.

### BACKGROUND

This invention relates to distributing user information in social networking systems, and in particular to distributing user information across replicated servers.

Online systems often store user information and receive queries that access the user information. For example, social networking systems store user profile information for each user including information identifying the user, demographic information, user's interests, privacy settings of the user, and other information explicitly provided by the user. The user profile may also include information that is inferred by the social networking system or collected by the social networking system, for example, the type of information accessed by the user, the rate of interactions of the user with the social networking system, rate of interaction of the user with other users, and the like. As a result, significant amount of storage may be required to store information describing each user.

Information describing a user needs to be accessed by the social networking system frequently and on a regular basis. For example, privacy settings of users may be accessed to determine whether one user's interactions can be reported to friends of the user in the social networking system. Similarly, if the social networking system determines whether certain content should be recommended to a user, the social networking system accesses the interests of the user to determine whether the content is likely to be of interest to the user.

The amount of user information stored by online systems can be significantly large. For example, online systems can have hundreds of millions of users and a large amount of data may have to be stored for each user. Managing such large amount of user information can be a challenge for online systems. Typically user data of such large magnitude cannot be stored in a single computer and is distributed across a large number of computers. The online system needs to ensure that the information describing the users can be efficiently accessed and is also readily available in spite of failures of individual computers storing the data. Conventional mechanisms of distributing user data across computers may result in unavailability of user data fir some of the users in case of failure of one or more servers storing the information.

### SUMMARY

Embodiments of the invention allow online systems to store and process information describing a large number of users. Online systems, for example, social networking systems can store information describing hundreds of millions of users. The information is distributed across multiple servers since typically a single server is unable to store or process information of such large magnitude. Embodiments distribute information across servers such that the information is available even in case of failure of some of the servers.

In an embodiment, the user information is distributed across a first set of servers and a second copy of the user information is distributed across a second set of servers. In case a server from the first set fails, the requests for user information stored on the failed server are directed to servers from the second set. If a copy of the entire information stored on one server from the set is stored on a single server from the second set, the server from the second set can get a large number of requests. Therefore, embodiments distribute the second copy of user information from each server of the first set across multiple servers from the second set. As a result, if a server from the first set fails, the requests previously directed to the failed server are distributed across multiple servers from the second set. The user information from each server of the first set are uniformly distributed across multiple servers from the second set, for example, using random distribution, round robin strategy, or any other strategy that uniformly distributes the information across a given set of processors. In an embodiment, the servers from the first set of servers overlap servers from the second set of servers. For example, user information from each server of the first set may be distributed across remaining servers of the first set.

The features and advantages described in this summary and the following detailed description are not all-inclusive. Many additional features and advantages will be apparent to one of ordinary skill in the art in view of the drawings, specification, and claims.

### BRIEF DESCRIPTION OF THE DRAWINGS

FIG. 1 is a diagram of a system environment for distributing user data across multiple servers and dispatching client requests to appropriate servers, in accordance with an embodiment of the invention.

FIG. 2A illustrates the system architecture of an online system, in accordance with an embodiment of the invention.

FIG. 2B is a diagram of system architecture of the aggregator module of the online system that dispatches requests to individual servers, in accordance with an embodiment of the invention.

FIG. 3 illustrates the distribution of user information across servers, in accordance with an embodiment of the invention.

FIG. 4 is a flowchart of the overall process for distributing user information across servers, in accordance with one embodiment of the invention.

FIG. 5 is a flowchart of the process for processing requests for user information in case user data mapped to a particular server is unavailable, in accordance with one embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Environment

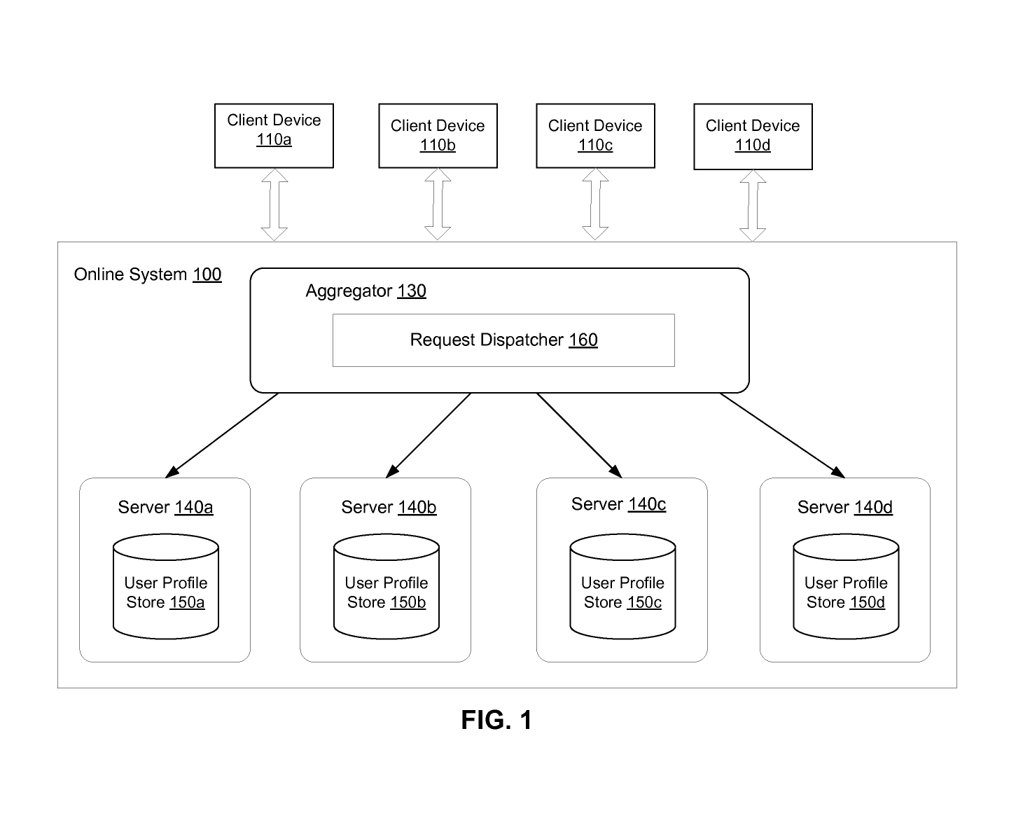

FIG. 1 is a diagram of a system environment for distributing user data across multiple servers and dispatching client requests to appropriate servers, in accordance with an embodiment of the invention. FIG. 1 and the other figures use like reference numerals to identify like elements. A letter after a reference numeral, such as “110A,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a” and/or “110b” in the figures).

The users interact with the online system 100 using client devices 110. The online system 100 maintains user profiles comprising information describing users of the online system 100. User profile may also be referred to herein as user information or user profile information and represents information of different types associated with the user stored in the social networking system including demographic information, features describing the users, user actions performed by the user, and so on. The online system 100 distributes the user profiles across multiple servers 140. Each user profile may be assigned to one or more servers 140. For example, copies of the user profile may be stored on different servers 140. In an embodiment, the server simply provides storage that can be accessed by the online system 100, for example, via file sharing. In other embodiments, the each server 140 has software modules that allow processing of requests directed to the server 140. In an embodiment, the online system 100 comprises software modules executing on one or more computer processors. Some embodiments of the systems 100 and 110 have different and/or other modules than the ones described herein, and the functions can be distributed among the modules in a different manner than described here.

Each server 140 stores user profile objects in the user profile store 250. The user profile store 150 stores information describing the users of the online system 100, including biographic, demographic, and other types of descriptive information, such as work experience, educational history, gender, sexual preferences, hobbies or preferences, location, and the like. The user profile store 150 may also store content provided by the user, for example, images, videos, comments, and status updates.

In an embodiment, a user of the online system 100 can be an organization, for example, a business, a non-profit organization, a manufacturer, a provider, and the like. The type of information stored in a user profile of an organization may be different from the information stored in a user profile of an individual. For example, an organization may store information describing the type of business, financial nation associated with the organization, structure of the organization and so on.

In an embodiment, the online system 100 is a social networking system that allows users of the online system 100 to add connections to a number of other users of the social networking system to whom they desire to be connected. A social networking system stores connection objects that store information describing relations between two users of the social networking system. Connections may be added explicitly by a user, for example, the user selecting a particular other user to be a friend, or automatically created by the social networking system based on common characteristics of the user (e.g., users who are alumni of the same educational institution). Social networking systems may store information associated with connections of a user along with the information specific to the user. As a result, the information stored for each user in a social networking system can be larger than typical online systems.

Social networking systems may provide various mechanisms to users to communicate with each other or to obtain information that they find interesting, for example, activities that their friends are involved with, applications that their friends are installing, comments made by friends on activities of other friends etc. The mechanisms of communication between members are called channels. If a user communicates with another user, the user information of both users may have to be accessed, for example, to associate the action of communicating with the sender and the receiver.

A social networking system may associate actions taken by users with the user's profile, through information maintained in a database or other data repository. Such actions may include, for example, sending a message to other users, reading a message from the other user, viewing content associated with the other user, among others. In addition, a number of actions performed in connection with other objects are directed at particular users, so these actions are associated with those users as well.

In an embodiment, the social networking system identifies information of interest to various users and sends the information to them. For example, the social networking system may send to a user, stories describing actions taken by other users that are connected to the user. The story may be communicated to the user via a channel of communication of the social. networking system, for example, a newsfeed channel. The social networking system accesses the user profiles of various users to determine stories of interest to each user based on actions taken by other users.

The online system 100 may provide users with the ability to take actions on various types of entities supported by the website. These entities may include groups or networks (where “networks” here refer not to physical communication networks, but rather to social networks of people) to which members of the website may belong, events or calendar entries in which a member might be interested, computer-based applications that a member may use via the website, and transactions that allow members to buy, sell, auction, rent, or exchange items via the website. A user profile may store associations of a user with various entities.

Users interact with the online system 100 using a client device 110. In one embodiment, the client device 110 can be a personal computer (PC), a desktop computer, a laptop computer, a notebook, a tablet PC executing an operating system, for example, a Microsoft Windows-compatible operating system (OS), Apple OS X, and/or a Linux distribution. In another embodiment, the client device 105 can be any device having computer functionality, such as a personal digital assistant (PDA), mobile telephone, smartphone, etc.

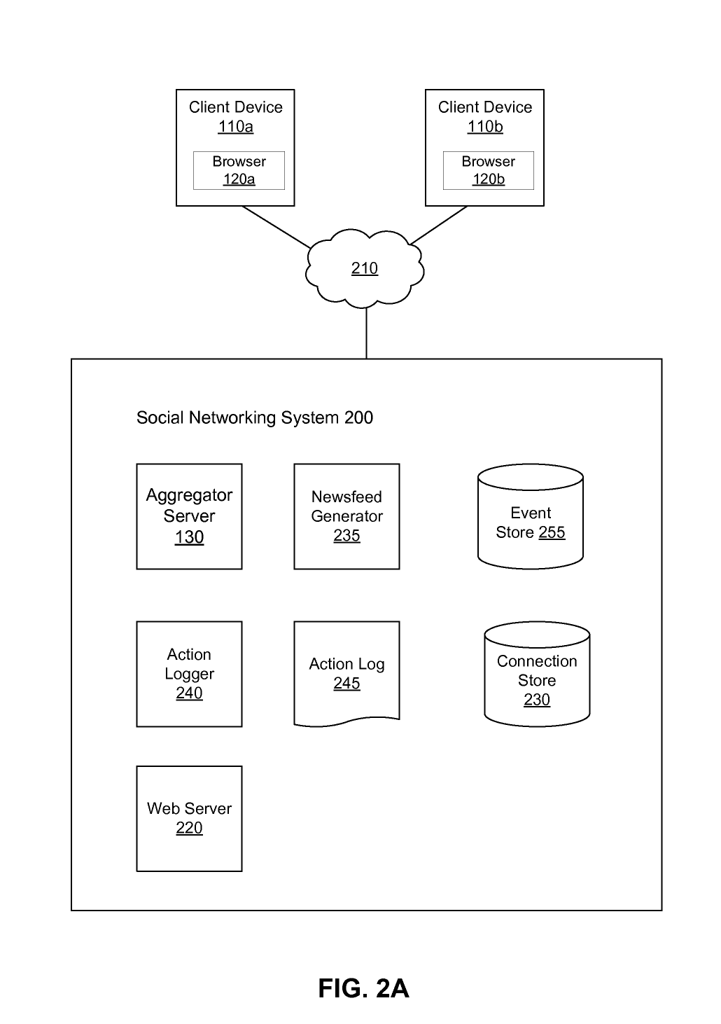

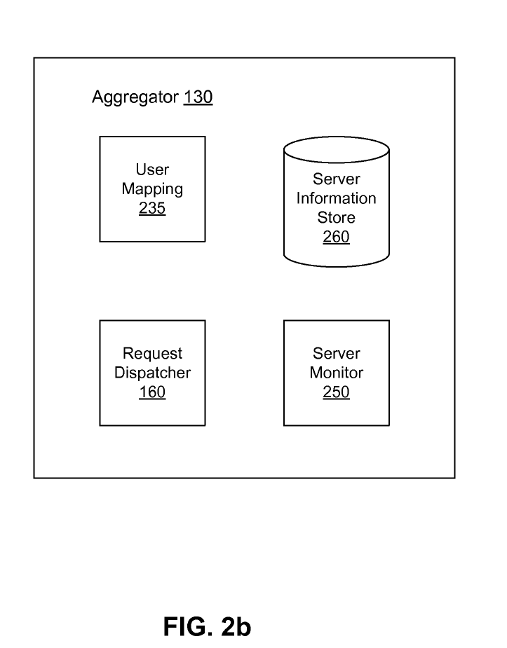

The online system 100 may comprise modules other than those shown in FIG. 1, for example, modules illustrated in FIG. 2 that are further described herein.

### System Architecture

FIG. 2A is a diagram of system architecture of an embodiment of an online system 100 which is a social networking system 200. Although the social networking system is described herein as an example online system, the principles described herein are applicable to other online systems. The social networking system 200 includes the aggregator 120, a newsfeed generator 235, web server 220, an action logger 240, an action log 245, a connection store 230, and an event store 260. In other embodiments, the social networking system 200 may include additional, fewer, or different modules for various applications. Conventional components such as network interfaces, security mechanisms, load balancers, failover servers, management and network operations consoles, and the like are not shown so as to not obscure the details of the system.

The social networking system 200 stores data describing one or more connections between different members in the connection store 230. The connection information may indicate members who have similar or common work experience, group memberships, hobbies, or educational history. Additionally, the social networking system 200 includes user-defined connections between different users, allowing users to specify their relationships with other users. For example, these user-defined connections allow members to generate relationships with other users that parallel the users' real-life relationships, such as friends, co-workers, partners, and so forth. Users may select from predefined types of connections, or define their own connection types as needed. User information describing each user may include information describing connections of the user. Furthermore, information describing a connection of a user may be stored as part of user information. Furthermore, actions taken b y users may also be stored as part of user information, for example, if the user interacts with the user's connections in the social networking system, the social networking system may store information describing these interactions as user information associated with the user.

A social networking system 200 maintains a newsfeed channel that provides regular updates of information available in the social networking system 100 to a user. The information reported via the newsfeed channel is determined by the newsfeed generator 235. The newsfeed generator 235 generates messages for each user about information that may be relevant to the user, based on actions stored in the action log 245. These messages are called “stories”; each story is an message comprising one or a few lines of information based on one more actions in the action log that are relevant to the particular member. For example, if a connection of a user performs a transaction, the action may be reported to the user via a newsfeed story. The actions reported via the newsfeed are typically actions performed by connections of the user but are not limited to those. For example, if certain information unrelated to the connections of the user is determined to be useful to the user, the information can be reported to the user via a newsfeed. Generating these newsfeed stories requires access to user information describing both the recipient of the newsfeed and the subject of the newsfeed.

The action logger 240 is capable of receiving communications from the web server 220 about user actions on and/or off the social networking system 100. The action logger 240 populates the action log 245 with information about user actions to track them. Any action that a particular user takes with respect to another user is associated with each user's profile, through information maintained in a database or other data repository, such as the action log 245. Such actions may include, for example, adding a connection to the other user, sending a message to the other user, reading a message from the other user, viewing content associated with the other user, attending an event posted by another user, among others.

The web server 220 links the social networking system 100 via the network 210 to one or more client devices 105; the web server 220 serves web pages, as well as other web-related content, such as Flash, XML, and so forth. The web server 220 provides the functionality of receiving and routing messages between the social networking system 100 and the client devices 105. These messages can be instant messages, queued messages e.g., email), text and SMS (short message service) messages, or any other suitable messaging technique. In some embodiments, a message sent by a user to another can be viewed by other users of the social networking system 100, for example, by the connections of the user receiving the message. An example of a type of message that can be viewed by other users of the social networking system 100 besides the recipient of the message is a wall post. A wall post allows a user to post a message via a communication channel called wall that can be accessed by a set of users as defined by the privacy settings of the user. For example, a user can share the user's wall with all the connections of the user, with a subset of connections of the user, with all connections except a few specifically listed connections, or by a list of connections explicitly provided. In some embodiments, a user can send a private message to another user that can only be accessed by the other user. The social networking system may access user information while communicating these messages, for example, the social networking system may access user information of the sender and recipient or recipients of the message.

The event store 255 stores information describing events associated with the social networking system 100. An event object may be defined for a real-world event, such as a birthday party. A user interested in attending the event may establish a connection with the event object. A user may create the event object by defining information about the event such as the time and place and a list of invitees. Other users may send a reply to the invitation (an RSVP message) i.e., accept or reject the invitation, comment on the event, post their own content (e.g., pictures from the event), and perform any other actions enabled by the social networking system 200 for the event. Accordingly, the creator of the event object 190 as well as the invitees for the event may perform various actions that are associated with that event object.

The client device 110 executes a browser 120 to allow the user 135 to interact with the social networking system 200. The browser 120 allows the user 135 to perform various actions using the social networking system 100. These actions include retrieving information of interest to the user, recommending content to other users, upload content to the social networking system 100, interact with other users of the social networking system, establish a connection with a user of the social networking system, and the like.

The interactions between the client devices 110 and the online system 100 are typically performed via a network 210, for example, via the internet. The network 210 enables communications between the client device 110 and the online system 100. In one embodiment, the network 210 uses standard communications technologies and/or protocols. Thus, the network 210 can include links using technologies such as Ethernet, 802.11, worldwide interoperability for microwave access (WiMAX), 3G, digital subscriber line (DSL), asynchronous transfer mode (ATM), InfiniBand, Express Advanced Switching, etc. Similarly, the networking protocols used on the network 210 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 210 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 210 can also include links to other networks such as the Internet.

FIG. 2B is a diagram of system architecture of the aggregator module 130 of the online system that dispatches requests to individual servers, in accordance with an embodiment of the invention. The aggregator module 100 comprises modules including a user mapping module 235, a request dispatcher module 160, a server monitor 250, and a server information store 260. The user mapping module 235 determines and keeps track of the mapping from user information to servers 140. In an embodiment, the user mapping module 235 maps user profile information to a server by mapping an identifier corresponding to each user to an identifier of a server. For example, the user identifier may be mapped to a server by using a function that can be computed by the user mapping module 235. In other embodiments, the user mapping module may store a mapping table that stores the mapping information, for example, a table that has at least two columns including a user identifier column and a server identifier column. The user information for the same user may be mapped to more than one server. Mapping user information to multiple servers provides redundancy, so that the user information is available even if one of the servers storing the user information is not available, for example, if the server fails.

The request dispatcher 160 receives requests for information describing users and directs the requests to the appropriate server 140a. The request for information describing each user may be received from a client or may be generated within the online system 100 for certain processing performed by the online system. For example, a news feed generator module 235 of the social networking system 200 may request information describing a user to determine whether certain stories are of interest to the user. Similarly, if a user sends a request to establish a connection with another user, the social networking system may access information describing both the users being connected.

The server monitor 250 monitors the health of the servers 140 to determine which servers are responding. For example, the server monitor 250 may sent a message periodically to each server 140 and wait for response from the server 140. A message sent for checking the health of a server may be called a ping message. If the server 140 fails to respond before a threshold time period, the server monitor 250 may determine that the server 140 has failed. In other embodiments, the server monitor 250 may send try sending messages multiple times to a server and waiting for a response for each message from the server before determining that the server has failed. Subsequently, the server monitor 250 may monitor a failed server to determine when the server recovers and starts functioning again. In some embodiments, a server that recovers from a failure automatically sends a message to the server monitor 250 informing the server monitor of the change of status of the server. Once the server monitor determines that the previously failed sever is functioning again, the server monitor 250 updates the information stored in the server information store 260. Subsequently, requests for user information stored in the recovered server is directed to the recovered server instead of servers acting as backup for the recovered server. In an embodiment, a server may not be available to process requests because the server is taken offline, for example, to perform maintenance.

The server information store 260 stores information describing the various servers that store user profile information. This information may comprise the health of individual servers as determined by the server monitor 250. The health of each server indicates whether the server is currently available to process requests or unavailable. The information describing each server may also describe the configuration of each server, for example, information describing the amount of storage in each server, processing capacity of the server, and the like. The description of a server may be used by the user mapping module 235 to determine how many users are mapped to the server. For example, more users may be mapped to a powerful server as compared to less powerful server. Similarly, if the server has larger storage capacity, more users may be mapped to the server.

In an embodiment, the request dispatcher 160 dispatches requests based on information describing the health of each server as determined by the server monitor 250 and stored in the server information store 260. For example, if a server 140 is determined to be failed, the request dispatcher sends request for information describing users mapped to the failed server to other server where a copy of the corresponding user information is stored.

### Distributing User Information

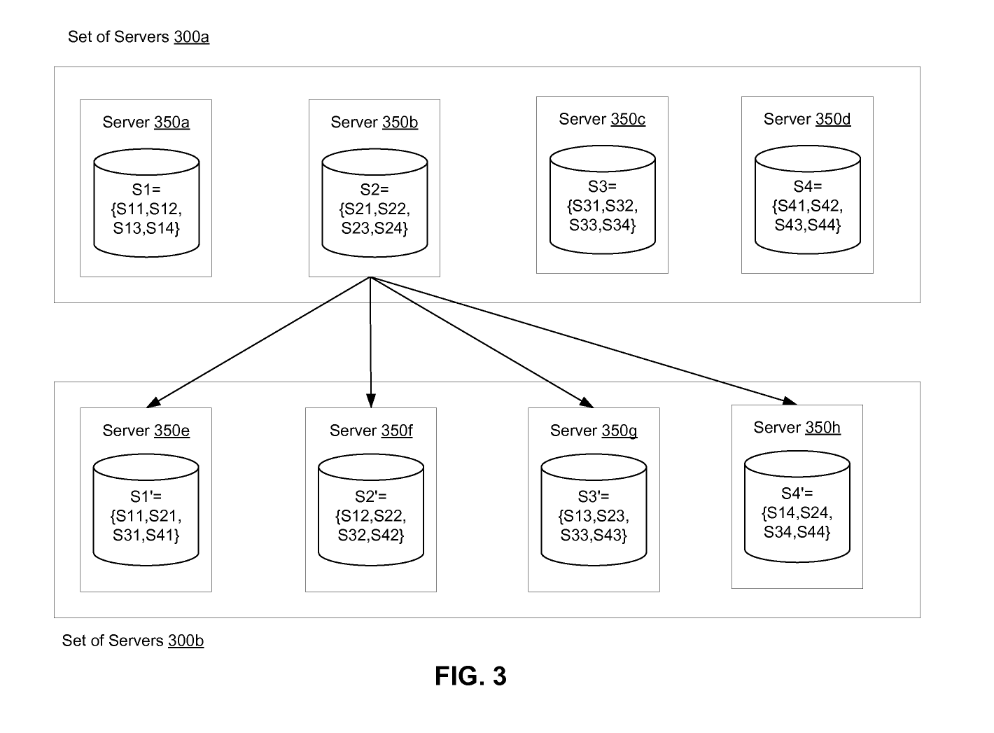

FIG. 3 illustrates the distribution of user information across servers, in accordance with an embodiment of the invention. Each server 350 can be a server 140 or any other server configured to store user profile information. User profile information herein refers to any type of information describing a user that needs to be accessed by a system for processing. The user profile information for each user may be mapped to one or more servers 350.

As illustrated in FIG. 3, the servers 350 are divided into two sets of servers, 300a and 300b. The sets 300a and 300b may be overlapping or non-overlapping sets. FIG. 3 shows an example configuration comprising set 300a including 350a, 350b, 350c, and 350d and the set 300b comprises servers including 350e, 350f 350g, and 350h. These are example configurations and other configurations may have more or less servers per set. Furthermore, the number of servers in the two sets can be different.

In an embodiment, the user profile information of all users is distributed uniformly across the servers of set 300a. For example, if all servers shown in FIG. 3 are assumed to have similar configuration, each server may be assigned the same number of user profiles. In an embodiment, the number of user profiles mapped to each server is determined based on the configuration of each server. For example, a powerful server that can respond to requests at a higher rate may be assigned more user profiles. A mapping from user profiles to servers in set 300a may be defined as a function. For example, N user profiles can be mapped to Al servers by mapping a user profile identified using an integer value i to the server (i div M) where div is an integer division operation that returns the quotient obtained by dividing i by M. The integer i associated with each user can be a counter that is obtained by listing the users in a particular order, for example, alphabetic order based on information uniquely identifying each user. In an embodiment, the value i associated with a user profile used for mapping a user to a server is an identifier of the user that uniquely identifies the user within the online system. In another embodiment, the value i associated with a user may be obtained by determining a hash value based on information that uniquely identifies the user, for example, the full name of the user and date of birth of the user, or the social security number of the user if available.

Each user profile is further mapped to a server of the set 300b and a copy of the corresponding user profile stored on at least a server of the set 300b. This makes sure that if a server from set 300a is not available, the user profiles mapped to the unavailable servers can be obtained from the servers in set 300b. As a result, the request dispatcher 160 directs the request for a user profile stored in the unavailable server from set 300a to the appropriate server storing a copy of the user profile in set 300b. However, if all user profiles of the failed server in set 300a were mapped to the same server from set 300b, all the requests previously directed to the failed server are now redirected to the corresponding server from set 300b. If the number of servers in set 300b is less than the number of servers in set 300a, the load on a server of set 300b can be very high in case one or more servers of set 300a fail. In order to equally distribute the requests for the failed server or servers from set 300a across multiple servers from set 300b, the user mapping module 235 distributes the user profiles stored on each server from set 300a across multiple servers of set 300b.

In an embodiment, the user mapping module 235 maps the user profiles of each server in set 300a randomly across the servers of set 300b. In other words, each user profile mapped to server X from set 300a is mapped to a randomly selected server from set 300b. Since a random distribution across the set of servers from set 300b is equally likely to select any given server from the set 300b, the user profiles mapped to each server from set 300b get uniformly distributed across the servers from set 300b. This ensures uniform distribution of load across processors of set 300 in case of failures of servers from set 300a.

In another embodiment, the user mapping module 235 selects user profiles stored on each server of set 300a and maps them across servers from set 300b in a round robin fashion. If the servers of the set 300b are assumed to be ordered from 0 to M−1, the user mapping module 235 selects user profiles from a server of set 300a in a particular order and maps the user profile encountered to the j^{th} server in the set 300b where j=(i mod M) where mod is the remainder operator.

In yet another embodiment, the user mapping module 235 selects user profiles stored on each server of set 300a and divides them into M equal subsets where M is the number of servers in set 300b. As a result, the user mapping module 235 maps user profiles of each server in set 300a such that a subset of consecutively encountered user profiles from the set is mapped to a server of set 300b. If the servers of the set 300b are assumed to be ordered from 0 to M−1, the user mapping module 235 selects user profiles from a server of set 300a in a particular order and maps the i^{th} user profile encountered to the j^{th} server in the set 300b where j=(i div M) where div is the quotient operator.

In another embodiment, the user profiles of set server from set 300a may be mapped to a subset of servers from the set 300b. The sets 300a and 300b may overlap. For example, an embodiment, the sets 300a and 300b are identical, i.e., they have the same servers as elements. The user profiles mapped to any particular server are uniformly distributed across servers other than the particular server. For example, if the set of servers includes servers A, B, and C, copies of user profiles stored in server A are uniformly distribute across servers B and C, copies of user profiles stored in server B are uniformly distributed across servers A and C, copies of user profiles from server C are mapped to servers A and B.

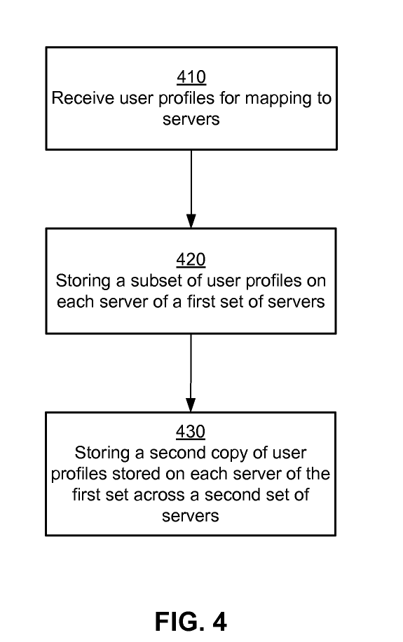

FIG. 4 is a flowchart of the overall process for distributing user information across servers, in accordance with one embodiment of the invention. The user mapping module 235 receives 410 a set of user profiles to map to servers 350. The set of user profiles can be the entire set of user profiles stored in the online system 100 or a new set of user profiles for mapping. In an embodiment, the user profiles may not be received at the same time but at different time points, for example, when different users create user profiles.

The user mapping module 235 distributes 420 the user profiles across a first set of servers in a way that a subset of the received set is stored on each server. The user mapping module 235 further stores 430 a second copy of the user profiles stored in each server from the first set such that the user profiles stored on each server from the first set are mapped across a second set of servers.

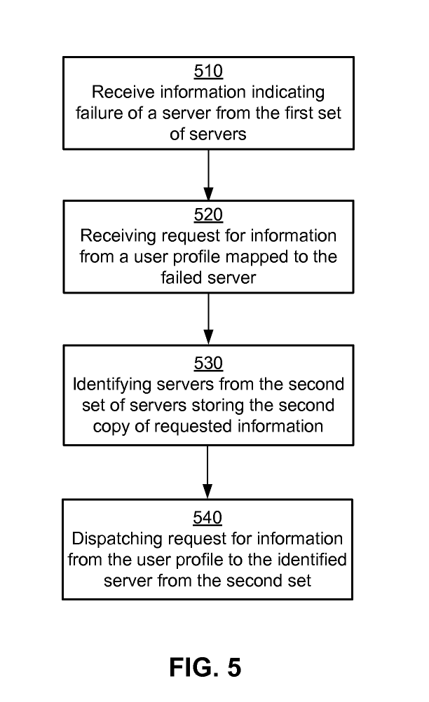

The process described in FIG. 4 helps redistribute requests in a load balanced manner across servers in case of a failure of one server. FIG. 5 is a flowchart of the process for processing requests for user information in case user data mapped to a particular server is unavailable, in accordance with an embodiment of the invention. The server monitor 250 receives 510 information indicating a failure of a server from the first set of servers as described in the process of FIG. 4. The server monitor 250 stores the information received in the server information store 260. The request dispatcher 160 obtains the status of various servers from the server information store 260 to determine which servers to dispatch incoming requests to.

The request dispatcher 160 receives 520 a request for information from a user profile that was stored in the failed server. The request dispatcher 160 determines the server from the second set that stores a second copy of the user profile. The request dispatcher 160 dispatches the request for information from the user profile to the identified server from the second set of servers that stores a second copy of the user profile. The process described in FIG. 5 is repeated form each incoming request. Since there can be several requests for user profiles stored on the failed server, these requests are uniformly distributed across servers from the second set.

### Alternative Applications

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, white described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, atone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible compute readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by an online system, user profiles describing users of a system;
storing a first copy of user profiles in a first plurality of servers, such that a set of user profiles is mapped to each server of the first plurality of servers;
for each server from the first plurality, the server storing a set of user profiles:
mapping the set of user profiles to a second plurality of servers, such that a subset of user profiles from the set is mapped to each server of the second plurality;
storing a second copy of the set of user profiles in the second plurality of servers according to the mapping;
receiving information describing failure of a server from the first plurality;
receiving requests for information stored on the failed server, each request identifying a user profile stored on the failed server; and
for each request identifying a user profile, identifying a server storing a second copy of the user profile and redirecting the request to the identified server.

2. The computer-implemented method of claim 1, wherein distributing the information describing the set of users stored on the server from the first plurality across multiple servers of the second plurality comprises:
mapping a subset of the set of users to each of the second plurality of servers.

3. The computer-implemented method of claim 1, wherein distributing the information describing the set of users stored on the server from the first plurality across multiple servers of the second plurality comprises:
mapping a subset of the set of users to each of the second plurality of servers, wherein each subset comprises substantially equal number of users.

4. The computer-implemented method of claim 1, wherein distributing the information describing the set of users stored on the server from the first plurality across all servers of the second plurality comprises:
mapping the set of users to each of the second plurality of servers using a random mapping that assigns each user of the set to a randomly selected server from the second plurality.

5. The computer-implemented method of claim 1, wherein distributing the information describing the set of users stored on the server from the first plurality across multiple servers of the second plurality comprises:
mapping the set of users to each of the second plurality of servers using scheme that assigns the users of the set in a round robin fashion to servers of the second plurality.

6. The computer-implemented method of claim 1, wherein distributing the information describing the set of users stored on the server from the first plurality across multiple servers of the second plurality comprises:
mapping a subset of consecutive users from the set of users to each of the second plurality of servers, the subset of consecutive users obtained based on an ordering of the users.

7. The computer-implemented method of claim 1, wherein the second plurality of servers overlaps with the first plurality of servers such that the second copy of a set of users stored on a first server is mapped to a subset of the first plurality of servers that excludes the first server.

8. A computer-implemented method comprising:
receiving information describing users of a system;
storing the information describing the users across a first plurality of servers, each of the plurality of servers storing information describing a set of users; and
for each server from the first plurality of servers, the server storing a first copy of information describing a set of users:
storing a second copy of information describing the set of users across a second plurality of servers, comprising:
distributing information describing the set of users across each of the second plurality of servers.

9. The computer-implemented method of claim 8, further comprising:
receiving information describing a failure of a first server from the first plurality; and
responsive to receiving information describing the failure of a first server:
receiving a requests for information describing users stored on the first server; and
distributing the received requests across the second plurality of servers, comprising, for each request for information describing a user:
identifying a second server from the second plurality of servers storing the second copy of information describing the second user; and
sending the request for information to the second server.

10. The computer-implemented method of claim 8, wherein distributing the information describing the set of users stored on the server from the first plurality across multiple servers of the second plurality comprises:
mapping a subset of the set of users to each of the second plurality of servers.

11. The computer-implemented method of claim 8, wherein distributing the information describing the set of users stored on the server from the first plurality across multiple servers of the second plurality comprises:
mapping a subset of the set of users to each of the second plurality of servers, wherein each subset comprises substantially equal number of users.

12. The computer-implemented method of claim 8, wherein distributing the information describing the set of users stored on the server from the first plurality across all servers of the second plurality comprises:
mapping the set of users to each of the second plurality of servers using a random mapping that assigns each user of the set to a randomly selected server from the second plurality.

13. The computer-implemented method of claim 8, wherein distributing the information describing the set of users stored on the server from the first plurality across multiple servers of the second plurality comprises:
mapping the set of users to each of the second plurality of servers using scheme that assigns the users of the set in a round robin fashion to servers of the second plurality.

14. The computer-implemented method of claim 8, wherein distributing the information describing the set of users stored on the server from the first plurality across multiple servers of the second plurality comprises:
mapping a subset of consecutive users from the set of users to each of the second plurality of servers, the subset of consecutive users obtained based on an ordering of the users.

15. The computer-implemented method of claim 8, wherein the second plurality of servers overlaps with the first plurality of servers such that the second copy of a set of users stored on a first server is mapped to a subset of the first plurality of servers that excludes the first server.

16. A computer program product having a non-transitory computer-readable storage medium storing computer-executable code for modifying a numeric value using a touch screen of a computing device, the code comprising:
a mapping module configured to:
receive information describing users of a system;
store the information describing the users across a first plurality of servers, each of the plurality of servers storing a first copy of information describing a set of users;
store a second copy of the information describing the users of the system across a second plurality of servers, comprising, for each server from the first plurality of servers:
distribute information describing a set of users stored on the server from the first plurality across multiple servers of the second plurality of servers; and
a server monitor module configured to:
receive information describing a failure of a first server from the first plurality;
an aggregator module configured to:
responsive to receiving information describing the failure of a first server:
receive a requests for information describing users stored on the first server;
distribute the received requests across the second plurality of servers, comprising, for each request for information describing a user:
identify a second server from the second plurality of servers storing the second copy of information describing the second user; and
send the request for information to the second server.

17. The computer program product of claim 16, wherein distributing the information describing the set of users stored on the server from the first plurality across multiple servers of the second plurality comprises:
mapping a subset of the set of users to each of the second plurality of servers.

18. The computer program product of claim 16, wherein distributing the information describing the set of users stored on the server from the first plurality across multiple servers of the second plurality comprises:
mapping a subset of the set of users to each of the second plurality of servers, wherein each subset comprises substantially equal number of users.

19. The computer program product of claim 16, wherein distributing the information describing the set of users stored on the server from the first plurality across all servers of the second plurality comprises:
mapping the set of users to each of the second plurality of servers using a random mapping that assigns each user of the set to a randomly selected server from the second plurality.

20. The computer program product of claim 16, wherein distributing the information describing the set of users stored on the server from the first plurality across multiple servers of the second plurality comprises:
mapping the set of users to each of the second plurality of servers using scheme that assigns the users of the set in a round robin fashion to servers of the second plurality.

21. The computer program product of claim 16, wherein distributing the information describing the set of users stored on the server from the first plurality across multiple servers of the second plurality comprises:
mapping a subset of consecutive users from the set of users to each of the second plurality of servers, the subset of consecutive users obtained based on an ordering of the users.

22. The computer program product of claim 16, wherein the second plurality of servers overlaps with the first plurality of servers such that the second copy of a set of users stored on a first server is mapped to a subset of the first plurality of servers that excludes the first server.
